(19) United States
(12) Patent Application Publication
(10) Pub. No.: US 2015/0370473 A1
(43) Pub. Date: Dec. 24, 2015

(54) USING A SYMBOL RECOGNITION ENGINE

(71) Applicants: Zhigang Chen, Beijing (CN); Yong Li, Beijing (CN); Yunjian Zou, Beijing (CN); Zhi Chen, Beijing (CN)

(72) Inventors: Zhigang Chen, Beijing (CN); Yong Li, Beijing (CN); Yunjian Zou, Beijing (CN); Zhi Chen, Beijing (CN)

(73) Assignee: Nokia Corporation, Espoo (FI)

(21) Appl. No.: 14/410,361

(22) PCT Filed: Jun. 27, 2012
(86) PCT No.: PCT/CN2012/077639

§ 371 Date: Dec. 22, 2014

(51) Int. Cl. G06F 3/0488; G06F 1/16

(52) U.S. Cl. CPC G06F 3/04883; G06F 3/04886; G06F 1/1626; G06F 1/1637

(57) ABSTRACT

A method comprises receiving signals indicative of receipt of a dynamic input by a touch-sensitive transducer, the dynamic input defining a path on the touch-sensitive transducer, at least a first portion of the path being within a first region of the touch-sensitive transducer. The method further comprises determining if a second portion of the path of the dynamic input is within a second region of the touch-sensitive transducer, in response to determining that the second portion path of the dynamic input is within the second region of the display, using a symbol recognition engine to identify a command based on the path of the dynamic input, and causing an action to be performed based on the identified command.

### FIELD

The invention relates to the use of a symbol recognition engine.

### BACKGROUND

Modern touchscreen devices, such as smartphones and tablet computers, allow users to utilise many different applications. Typically, these applications are accessed by selecting an associated icon from a central menu.

### SUMMARY

In a first aspect, this specification describes a method comprising receiving signals indicative of receipt of a dynamic input by a touch-sensitive transducer, the dynamic input defining a path on the touch-sensitive transducer, at least a first portion of the path being within a first region of the touch-sensitive transducer. The method further comprises determining if a second portion of the path of the dynamic input is within a second region of the touch-sensitive transducer, in response to determining that the second portion path of the dynamic input is within the second region of the display, using a symbol recognition engine to identify a command based on the path of the dynamic input, and causing an action to be performed based on the identified command.

The touch-sensitive transducer may be part of a touchscreen device and the first region of the touch-sensitive transducer may overlie a display panel to form the touchscreen of the touchscreen device, and the second region of the touch-sensitive transducer may be located outside the perimeter of the display panel.

The path may originate in the second region and terminate in the first region. Alternatively, the path may originate in the first region and terminate in the second region.

The action may comprise switching from displaying an interface of a first application to displaying an interface of a second application. The action may comprise identifying at least one application based on the command and, for each of the at least one application, displaying a selectable image associated with the application. The method may further comprise responding to receipt of signals indicative of a user selection of one of the at least one selectable image by causing display of an interface of the application associated with the selected image.

In a second aspect, this specification describes apparatus comprising at least one processor and at least one memory including computer program code, the at least one memory and the computer program code configured, with the at least one processor, to cause the apparatus, to receive signals indicative of receipt of a dynamic input by a touch-sensitive transducer, the dynamic input defining a path on the touch-sensitive transducer, at least a first portion of the path being within a first region of the touch-sensitive transducer. The at least one memory and the computer program code are further configured, with the at least one processor, to cause the apparatus to determine if a second portion of the path of the dynamic input is within a second region of the touch-sensitive transducer, in response to determining that the second portion path of the dynamic input is within the second region of the display, to use a symbol recognition engine to identify a command based on the path of the dynamic input, and to cause an action to be performed based on the identified command.

In a third aspect, this specification describes computer-readable code which, when executed by computing apparatus, causes the apparatus to perform a method according to the first aspect.

In a fourth aspect, this specification describes a non-transitory computer-readable storage medium having stored thereon computer-readable code, which, when executed by computing apparatus, causes the computer apparatus to receive signals indicative of receipt of a dynamic input by a touch-sensitive transducer, the dynamic input defining a path on the touch-sensitive transducer, at least a first portion of the path being within a first region of the touch-sensitive transducer, to determine if a second portion of the path of the dynamic input is within a second region of the touch-sensitive transducer, in response to determining that the second portion path of the dynamic input is within the second region of the display, to use a symbol recognition engine to identify a command based on the path of the dynamic input, and to cause an action to be performed based on the identified command.

In a fifth aspect, this specification describes apparatus comprising means for receiving signals indicative of receipt of a dynamic input by a touch-sensitive transducer, the dynamic input defining a path on the touch-sensitive transducer, at least a first portion of the path being within a first region of the touch-sensitive transducer, means for determining if a second portion of the path of the dynamic input is within a second region of the touch-sensitive transducer, means for using a symbol recognition engine to identify a command based on the path of the dynamic input in response to determining that the second portion path of the dynamic input is within the second region of the display, and means for causing an action to be performed based on the identified command.

The apparatus may further comprise means for performing any of the operations described with reference to the first aspect.

### BRIEF DESCRIPTION OF THE FIGURES

For a more complete understanding of example embodiments, reference is now made to the following description taken in connection with the accompanying drawings in which:

FIG. 1 is a schematic illustration of apparatus according to example embodiments;

FIGS. 2A and 2B depict electronic devices according to example embodiments;

FIGS. 3A to 3C depict an electronic device performing operations in accordance with example embodiments;

FIGS. 4A and 4B depict an electronic device performing operations in accordance with example embodiments;

FIGS. 5A and 5B depict an electronic device performing operations in accordance with example embodiments;

FIGS. 6A and 6B depict an electronic device performing operations in accordance with example embodiments;

FIGS. 7A and 7B depict an electronic device performing operations in accordance with example embodiments; and

FIG. 8 is a flow chart illustrating a method according to example embodiments.

### DETAILED DESCRIPTION OF EMBODIMENTS

In the description and drawings, like reference numerals refer to like elements throughout.

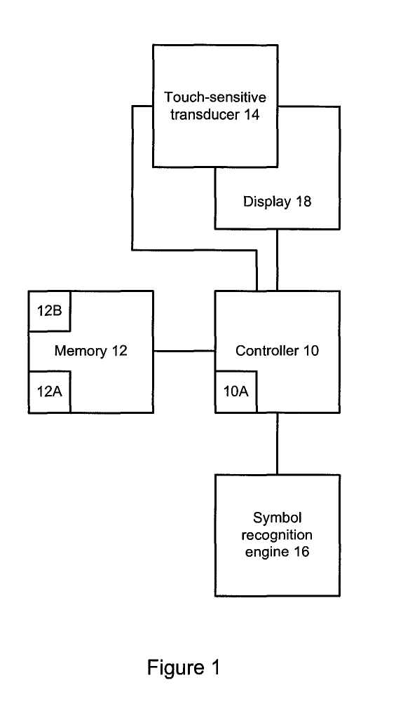

FIG. 1 is a schematic illustration of apparatus 1 according to example embodiments. The apparatus 1 comprises a controller 10 and at least one non-transitory memory medium 12. The apparatus 1 also comprises a touch-sensitive transducer 14 and a symbol recognition engine 16. In this example, the apparatus also comprises a display panel 18.

The controller 10 comprises at least one processor 10A which is operable to execute computer readable code 12A stored in the at least one memory 12. The controller 10 is operable, under the control of the computer readable code 12A to control the other components of the apparatus 1. The at least one processor 10A may comprise any suitable type, or any combination of suitable types, of processor or microprocessor. The controller 10 may also comprise one or more application specific integrated circuits (not shown). The at least one memory 12 may comprise any suitable type, or any combination of suitable types of memory medium. Suitable types of memory medium include, but are not limited to ROM, RAM and flash memory.

The touch-sensitive transducer 14 is operable to detect touch inputs provided thereon and to output to the controller 10 signals indicative of the touch inputs. Based on these signals, the controller 10 is operable to determine locations on to the touch-sensitive transducer 14 of the touch inputs. When the touch input is a dynamic touch input (e.g. a user dragging their finger across a surface of the touch-sensitive transducer 14), the controller 10 is operable to determine the path of the dynamic touch input on the surface of the touch-sensitive transducer 14. A path of the dynamic touch input is a series of locations on the surface of the touch-sensitive transducer 14 at which the user's finger was present as they moved their finger across the surface of the touch-sensitive transducer 14. The controller 10 is operable to control other components of the apparatus 1 based on the signals indicative of user inputs received from the touch-sensitive transducer 14.

The symbol recognition engine 16 is configured receive from the controller 10 path data indicative of the path of a dynamic touch input. This path data may include location data representing the locations on the touch-sensitive transducer 14 at which the dynamic touch input was incident. The path data may also include associated time data. The time data may indicate at least an order at which the locations were visited. The time data may also indicate relative times at which the locations were visited.

The symbol recognition engine 16 is operable use the path data received from the controller 10 to analyse the shape or configuration of the path of a dynamic touch input. Based on the analysis of the shape of the path, the symbol recognition engine 16 is configured to identify user commands. More specifically, the symbol recognition engine 16 is configured to recognise handwritten symbols, such as alphabetic characters, defined by the paths of the dynamic touch inputs and to identify user commands associated with the handwritten symbols. The symbol recognition engine 16 may also be operable to recognise strings or series of handwritten characters and the user commands associated therewith. As will be appreciated, the user commands associated with the handwritten characters may take many forms. For example, a user command may be a command to open or switch to a new application. In some examples, a user command may be a command to change a setting pertaining to a function or appearance of the device. Similarly, a user command identified by the symbol recognition engine 16 may be a command to search the memory 12 for applications and/or files having a name which includes one or more a letters or numbers recognised from the path of the dynamic touch input (i.e. the handwritten characters). The symbol recognition engine 16 may use any suitable technique, or combination of techniques, in order to identify user commands based on handwritten symbols.

The controller 10 is operable to use the symbol recognition engine 16 to identify user commands based on the handwritten symbols defined by the paths of the dynamic touch inputs. The controller 10 is operable also to perform actions based on the user commands identified by the symbol recognition engine 16.

The display panel 18 is operable under the control of the controller 10 to output images to a user of the apparatus 1. In some example embodiments, the touch-sensitive transducer 14 at least partially overlies the display panel 18, thereby to form a touchscreen.

Also, stored in the memory 12 is a plurality of applications 12B. These applications 12B are executable by the controller 10. The applications 12B may include, for example, an email application, an SMS/MMS application, a music player application, a mapping application, a calendar application, a browser application, gaming applications and a telephone application. It will of course be appreciated that the forgoing list is by way of example only and that the memory 12 may include any type of executable application 12B. It will be appreciated also that the identities of the applications 12B stored in the memory 12 may, to some extent, depend on the nature of electronic device into which the apparatus is incorporated. For example, a mobile telephone will include a telephone application, whereas a portable music player may not.

The apparatus 1 may be part of an electronic device, such as but not limited to a mobile telephone, a personal digital assistant, a laptop computer, a tablet computer, a desktop computer, an e-reader, and a media player.

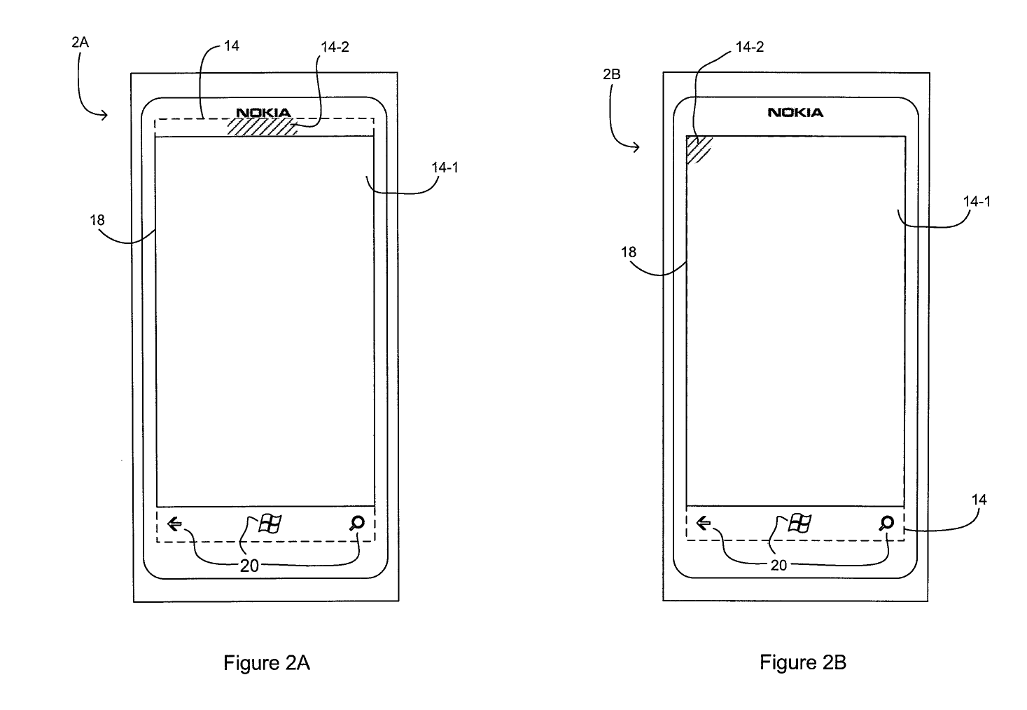

FIGS. 2A and 2B depict electronic devices 2A, 2B incorporating the apparatus 1 of FIG. 1. In this example, the electronic devices 2A, 2B are portable touchscreen devices. Specifically, the electronic devices shown in FIGS. 2A and 2B are touchscreen smartphones.

In both examples, the display panel 18 is delineated by a solid line. The touch-sensitive transducer 14, which is delineated in both examples by a broken line, partially overlies the display panel 18. As such, the display panel 18 and the touch-sensitive transducer 14 form a touchscreen.

Also in both examples, the touch-sensitive transducer 14 extends beyond the perimeter of the display panel 18. As such, the devices 2A, 2B comprise touch-sensitive regions which are not part of the touchscreen. Specifically, the touch-sensitive transducers 14 of both devices extend below the bottom edge of the display panel 18. This enables the device to have touch-sensitive, non-mechanical buttons or keys 20. These buttons 20 may have assigned functions or may be so-called “soft keys” for which the function changes depending on the application currently shown on the display. On the device 20A of the FIG. 2A, the touch-sensitive transducer also extends beyond the upper edge of the display panel 18. It will be appreciated of course that in some examples, the touch-sensitive transducer 14 may also extend beyond one or both of the side edges of the display panel 18. In some examples, other types of sensor may be used to detect input on the second region 14-2. For example, proximity or light sensing sensors, hovering detection, pressure sensors and/or the like may be used.

The touch sensitive transducers 14 of both devices 2A, 2B comprise a first region 14-1 and a second region 14-2. The second regions 14-2 in both examples are denoted by the diagonal hatching. The first and second regions 14-1, 14-2 are separate in the sense that they do not overlap with one another. However, they may be integrally formed with one another. Alternatively, they may be separated from one another by a physical boundary. In the examples of FIGS. 2A and 2B, the first and second regions 14-1, 14-2 are integrally formed. The controller 10 is operable to determine from the signals received from the touch sensitive transducer 14 on to which of the first and second regions 14-1, 14-2 a touch input is incident. The way in which this information is utilised by the controller 10 will become clear from the below description.

In the example of FIG. 2A, the second region 14-2 of the touch-sensitive transducer 14 is provided outside the perimeter of the display panel 18. In other words, in the example of FIG. 2A, the second region 14-2 of the touch-sensitive transducer 14 does not form part of the touchscreen. In contrast, in the example of FIG. 2B, the second region 14-2, overlies the display panel 18 and so does form part of the touchscreen. In both examples, the majority of the first region 14-1 overlies display panel 18 and so forms part of the touchscreen.

The size of the second region 14-2 of the touch-sensitive transducer 14 may vary. The second region 14-2 is preferably sufficiently large to enable a user easily to provide a touch input thereto. For example, an area of approximately 5 m×5 mm may be sufficient to allow a user easily to provide a touch input on the second region 14-2.

The location of the second region 14-2 of the touch-sensitive transducer 14 relative to the remainder of the touch-sensitive transducer 14 may vary. However, as will be appreciated from the below description, it may be beneficial for the second region 14-2 to be provided at a location on the touch-sensitive transducer 14 at which touch inputs are less likely to be received during normal use of the electronic device. For this reason, the second region 14-2 may be provided adjacent an edge of the touch-sensitive transducer 14. In some examples, the location of the second region 14-2 may vary depending on the orientation of the device 2. For example, the second region 14-2 may be provided such that it is always at an upper left-hand corner of the touch-sensitive transducer 14 regardless of how the device 2 is orientated. In some examples, two or more second regions 14-2 may be provided, for example at two or more corners of the touch sensitive transducer 14. The location of the second region 14-2 may also be user-settable, such that for example a left-handed user may configure it to be on the left-hand side of the device while a right-handed user might configure the region to be on the right-hand side. Alternatively or in addition, the location and/or the size of the region may be dynamically detected based on the user's handedness and how the user has typically gripped and held the device.

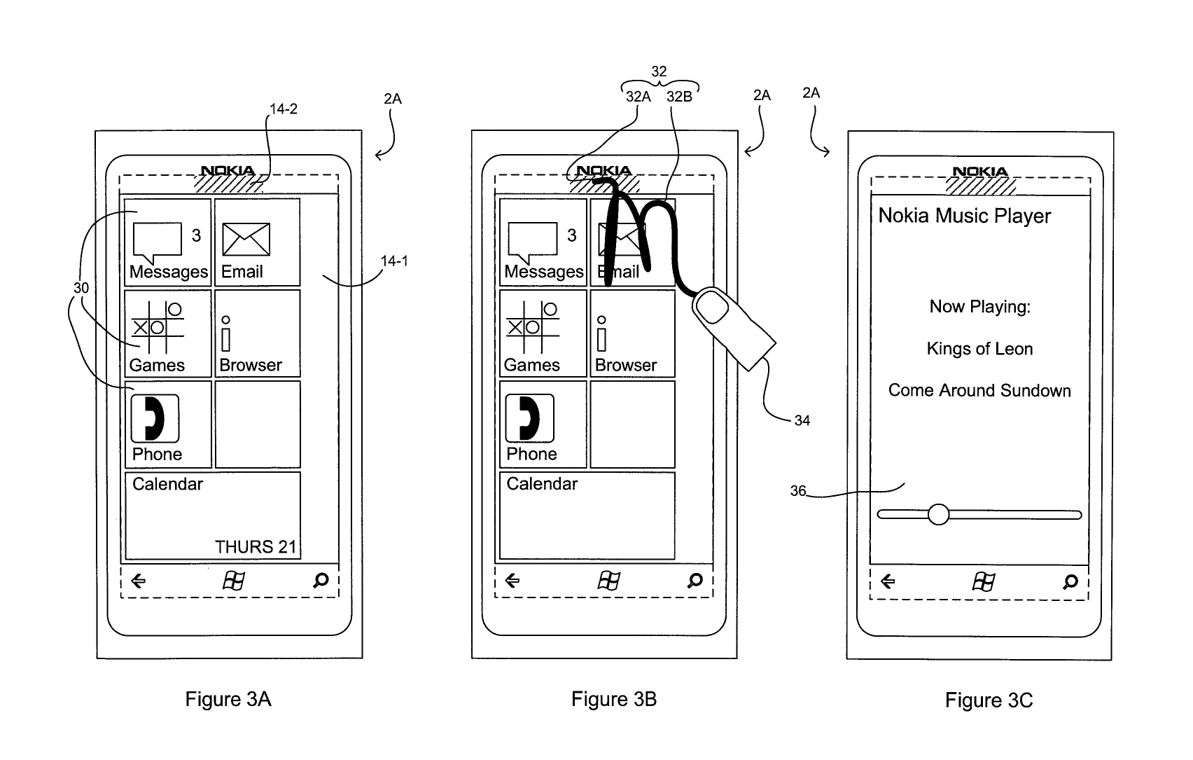

Various operations according to example embodiments will now be described with reference to FIGS. 3A to 7B.

FIG. 3A shows the electronic device 2A of FIG. 2A. As such, the second region 14-2 of the touch-sensitive transducer 14 is located outside the perimeter of the display panel 18. In this example, the controller 10 is causing a menu interface to be displayed on the display 18. The menu interface comprises a plurality of selectable images 30 or icons each representing an executable application 12B. The controller 10 is configured to respond to receipt of a static touch input (i.e. which is provided only at one location) in respect of one of the icons 30 to cause the application associated with the selected icon 30 to be executed. The controller 10 may be responsive to receipt of a dynamic touch input, the entire path of which is situated within the first region 14-1, to scroll to different parts and/or pages of the menu interface.

FIG. 3B shows a dynamic touch input having been received on the touch-sensitive transducer 14. The path 32 of the dynamic touch input is shown by the bold line. The finger 34 is illustrative only and indicates the terminus of the path 32. In other words, the position of the finger 34 on the Figure indicates the final location at which the user's finger was positioned when providing the dynamic touch input.

As can be seen from FIG. 3B, a portion 32A or part of the path 32 of the dynamic touch input is located within the second region 14-2 of the touch-sensitive transducer 14 and another portion 32B of the path 32 is provided in the first region 14-1 of the touch sensitive transducer 14. In this example, the path 32 starts within the second region 14-2 of the touch-sensitive transducer 14 and finishes in the first region 14-1 of the touch-sensitive transducer 14.

The controller 10 is configured, under the control of the computer-readable code 12A, to respond to a determination that the path 32 of a dynamic touch input is located partially within the second-region 14-2 of the touch-sensitive transducer 14 and partially within the first region 14-1 of the touch-sensitive transducer to use the language engine 16 to identify a user command based on the path 32 of the dynamic touch input. Put another way, the controller 10 is responsive to a determination that the path 32 of the dynamic touch input crosses a boundary between the first region 14-1 and the second region 14-2 of the touch-sensitive transducer 14 to use the language engine 16 to identify a user command based on the path 32 of the dynamic touch input. In some examples, in order for the controller 10 to respond in this way, it may be an additional requirement that the path 32 of dynamic touch input begins in one of the first and second regions 14-1, 14-2 and finishes in the other. In other examples, the controller 10 may respond by using the symbol recognition engine 16 to identify a user command based on the path 32 of the dynamic touch input only if the path starts in the second region 14-2 and terminates in the first region 14-1. Alternatively, it may be required that the path 32 starts in the first region 14-1 and terminates in second region 14-2.

In some examples, the controller 10 may cause the path 32 of the dynamic touch input to be displayed to the user on the display screen 18. This may occur in response to a determination that the dynamic touch input started in the second region 14-2 and has transitioned to the first region 14-1. After this determination, the controller 10 may cause the path 32 to be displayed to the user in near real-time as the dynamic input is provided by the user. In some example embodiments, the path of the touch input may not be visually indicated. In some example embodiments, haptic feedback could be provided such that the user is aware that the input is being registered.

If the path 32 does not include a portion in second region 14-2 of the touch-sensitive transducer 14 and a portion in the first region 14-1 of the touch-sensitive transducer 14, or if one of the other above-described requirements (e.g. the specific order in which the dynamic touch input should be provided in each of the regions 14-1, 14-2) is not met, the controller 10 does not utilise the symbol recognition engine to identify user commands based on the shape of the path. Instead, the controller 10 interprets the dynamic touch input normally. The way in which the dynamic touch input is interpreted may depend on the interface currently displayed on the display 18. For example, if the interface is a menu (as it is in FIG. 3B), the controller 10 may respond to the input by scrolling the menu. If the interface of a gaming application is displayed, the controller 10 may respond to the input as defined by the application.

Returning now to FIG. 3B, the path 32 of dynamic touch input is shaped like the alphabetic character “m” and has a portion 32A in the second region 14-2 of the touch-sensitive transducer 14 and a portion 32B in the first region 14-1 of the touch-sensitive transducer 14. The symbol recognition engine 16 analyses the shape of the path 32 and identifies the alphabetic character “m”. The symbol recognition engine 16 then identifies a user command associated with this character. In some examples, particular characters may be associated with user commands to execute, or switch to, particular applications 12B. In some examples, if a particular character is not associated with a command to execute a particular application, the symbol recognition engine 16 may instead identify the user command as an instruction to search the device 2 for all applications and/or files stored thereon which begin with or include the identified alphabetic character.

Subsequent to identifying the user command based on the shape of the path 32 of the dynamic touch input, the identified user command is passed back to the controller 10. The controller 10 is configured to perform an action based on this command. In the example of FIGS. 3A to 3C, the character “m” is associated with a command to execute or switch to a music player application. Consequently, in FIG. 3C, the controller 10 responds by executing the music player application and causing an interface 36 of the music player application to be displayed on the display screen 18. In some examples, if the required application is already running in the background, the controller 10 may not be required to initiate the required application, but may instead simply cause the interface of the required application to be displayed instead of the previously displayed application.

In some example embodiments, the location of the second region 14-2 of the touch-sensitive transducer 14 may be indicated to the user. This may be achieved in any suitable way. For example, the location of the second region 14-2 may be indicated visibly, in any suitable way. For example, when the second region 14-1 forms part of the touchscreen, a coloured or shaded area may be displayed on a region of the display 18 underlying the second region 14-2. When the second region 14-2 of the touch-sensitive transducer 14 is provided outside the perimeter of the display 18, the substrate underlying the second region 14-2 may be of a different colour to the immediately surrounding area. In other examples, the location of the second region may be indicated using haptic feedback. For example, when the user's finger is within the second region 14-2, the controller 10 may cause the device to vibrate.

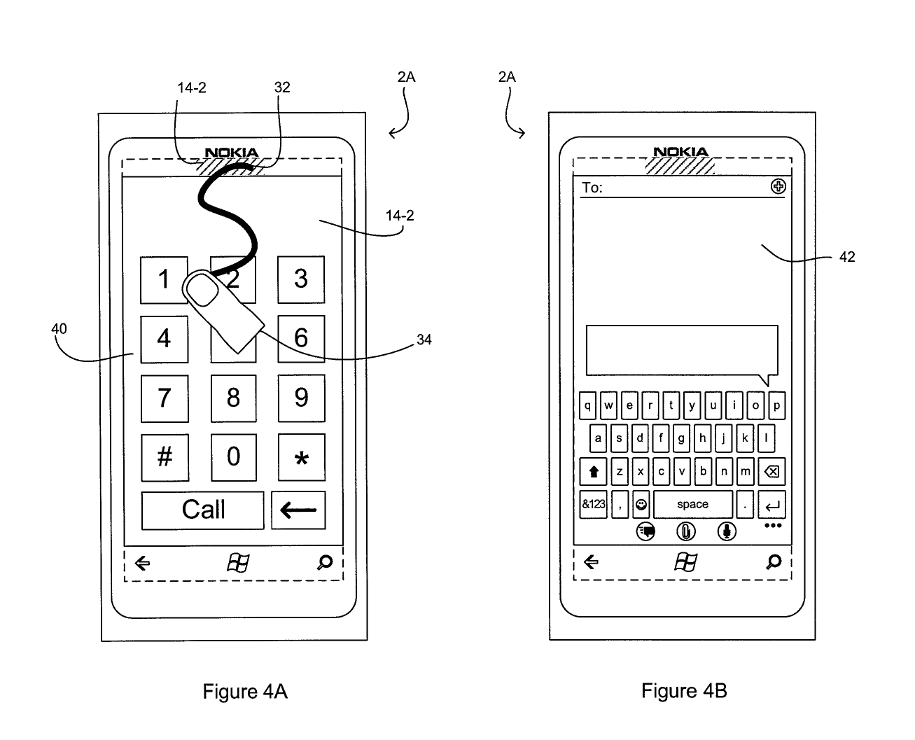

FIGS. 4A and 4B illustrate another operation according to example embodiments. In this example, the electronic device 2A is configured as configured as described in FIG. 2A, with the second region 14-2 of the touch-sensitive transducer 14 being provided outside the perimeter of the display panel 18.

In FIG. 4A, the controller 10 is causing an interface 40 of an application 12B, in this case a telephone application, to be displayed. The user, deciding that they wish to switch to another application, has provided a dynamic touch input starting in the second region 14-2 of the touch-sensitive transducer 14 and finishing in the first region 14-1 of the touch-sensitive transducer 14. In response to this, the controller 10 uses the symbol recognition engine 16 to analyse the shape of the path 32 of the dynamic touch input. In this example, the path 32 of the dynamic touch input is shaped similarly to the alphabetic character “s”. The symbol recognition engine 16 identifies this similarity and subsequently identifies a command associated with the recognised symbol. In this case, the alphabetic character “s” is associated with a command to execute or switch to an SMS application. The identified command is then returned to the controller 10, which performs a corresponding action. In this example, the controller 10 causes an interface 42 associated with the SMS application to be displayed on the display 18. This can be seen in FIG. 4B.

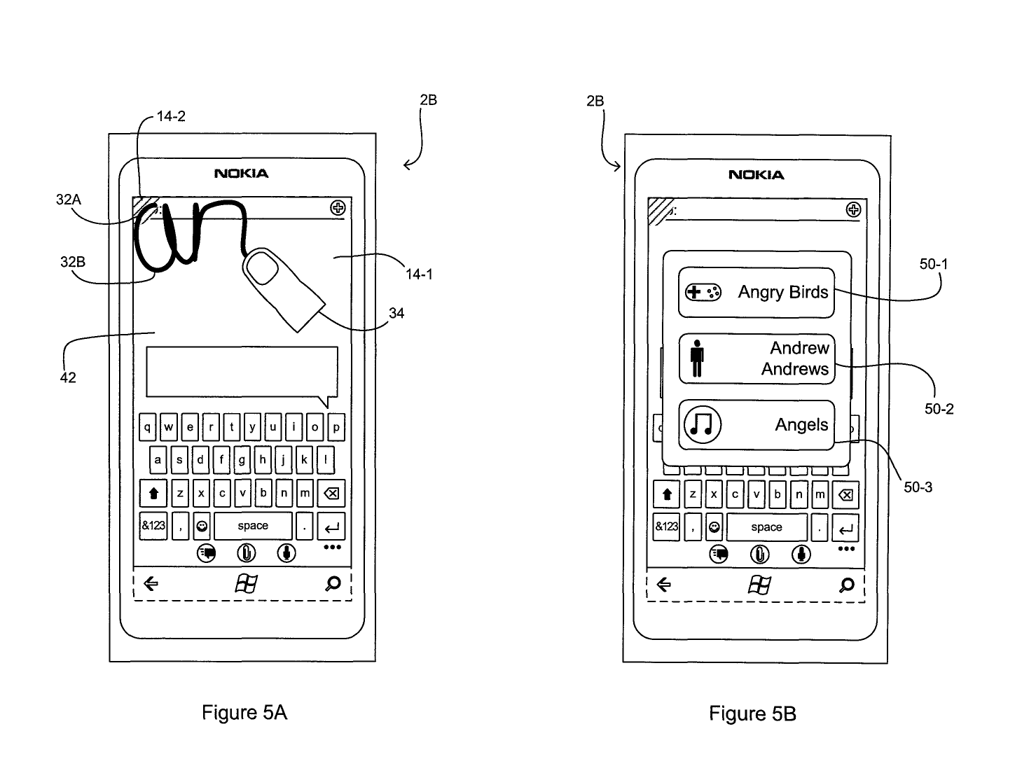

FIGS. 5A and 5B illustrate another operation according to example embodiments. In this example, the electronic device 2B is configured as described with reference to FIG. 2B (i.e. with the second region 14-2 of the touch-sensitive transducer 14 overlying the display panel 18). It will, however, be appreciated that the operation depicted in FIGS. 5A and 5B may instead be implemented on a device 2A such as that shown in FIG. 2A.

In FIG. 5A, the controller 10 is displaying an interface 42 of a first application, in this case the SMS application. The user, however, deciding they wish to perform another action provides a dynamic touch input having a path having a first portion 32A in the second region 14-2 of the touch-sensitive transducer 14 and a second portion 32B in the first region 14-1 of the touch-sensitive transducer 14. Consequently, the controller 10 responds by sending path data to the symbol recognition engine 16 for analysis. The symbol recognition engine 16 recognises that the path 32 is shaped like the alphabetic character “a” followed by the alphabetic character “n”. Following this determination, the symbol recognition engine 16 searches for a user command associated with this combination of characters. In this case, there is no specific application associated with the recognised characters. As such, the symbol recognition engine 16 instead determines that the user wishes to search the memory 12 of the device 2B to identify all applications, files and/or folders which begin with, or alternatively simply include, the recognised characters.

The instruction to search the device 2B is then returned to the controller 10 which performs the action accordingly. In this example, the search performed by the controller 10 returns three results: an application named “Angry Birds”, a contact of the user named “Andrew Andrews”, and a audio file entitled “Angels”. Consequently, as can be seen by FIG. 5B, the controller 10 causes a selectable image 50-1, 50-2, 50-3 associated with each identified application, file or folder to be displayed on the display 18. In this example, the selectable images 50-1, 50-2, 50-3 are overlaid on the previously presented interface 42. In other examples, the selectable images 50-1, 50-2, 50-3 may instead be displayed on a dedicated search results interface, or may be displayed in any other way.

Each of the images 50-1, 50-2, 50-3 is selectable. As such, the controller 10 responds to a user selection of one of the images 50-1, 50-2, 50-3, which in this example is provided via touch input, by causing the associated application, file or folder to be opened. Where the image is associated with a file or folder, selection of this image causes the controller 10 to execute or to transition to an application associated with the file or folder. The file or folder is then output to the user by the application. In the example, of FIG. 5B, selection of the image 50-1 associated with the application “Angry Birds” results in an interface of that application being displayed. A selection of the image 50-2 associated with the contact “Andrew Andrews” may cause an interface of a contacts application to be displayed. Selection of the image 50-3 associated with the audio file “Angels” may cause the audio file to be played by a music player application.

In the example of FIGS. 5A and 5B, the two handwritten characters are joined with one another such that they can be provided by a single, continuous dynamic touch input. The controller 10 and the symbol recognition engine 16 may also be operable to respond to the provision of a series of characters that are discrete (i.e. not joined up) and so are provided by more than one dynamic touch input. In such examples, following the provision of a first dynamic touch input, the path 32 of which has portions in both of the first and second regions 14-1, 14-2 of the touch-sensitive transducer 14, the controller 10 may be configured to wait a predetermined time before sending the path data to the symbol recognition engine 16. For example, a timer may be started when the first dynamic input finishes. The controller 10 may be configured to recognise that a dynamic touch input has finished if, for example, the user's finger is removed from the touch-sensitive transducer 14 or if the user's finger remains stationary for longer than a predetermined duration. If a user wishes to enter another character, they must begin providing the dynamic touch input prior to the expiry of the timer. The timer is then restarted when the second dynamic touch input finishes. This process repeats until the timer expires. At this point, all the path data is transferred to the symbol recognition engine 16 for analysis.

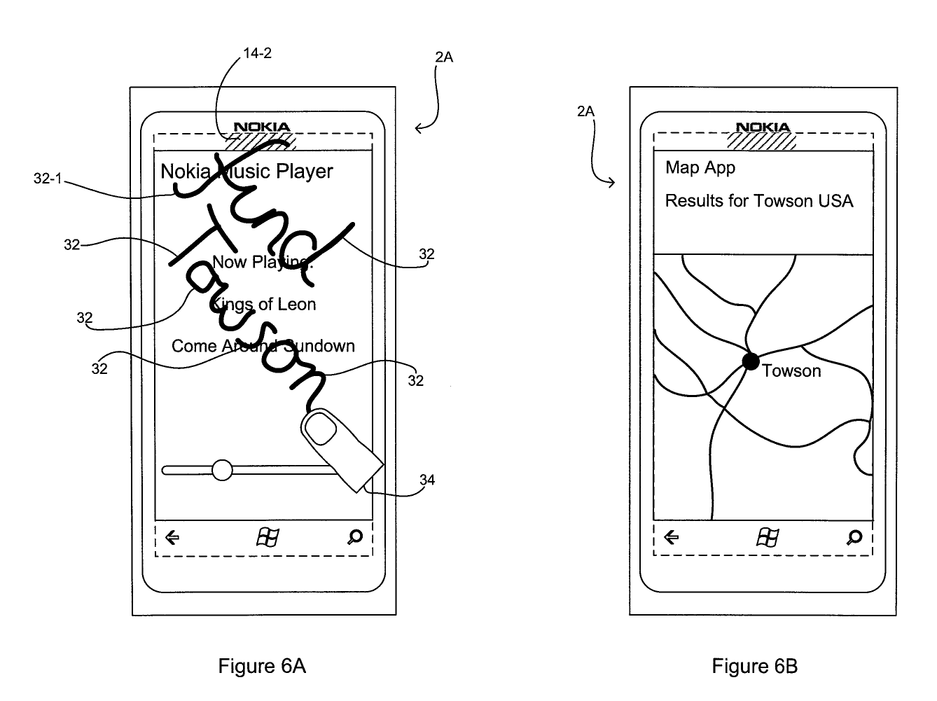

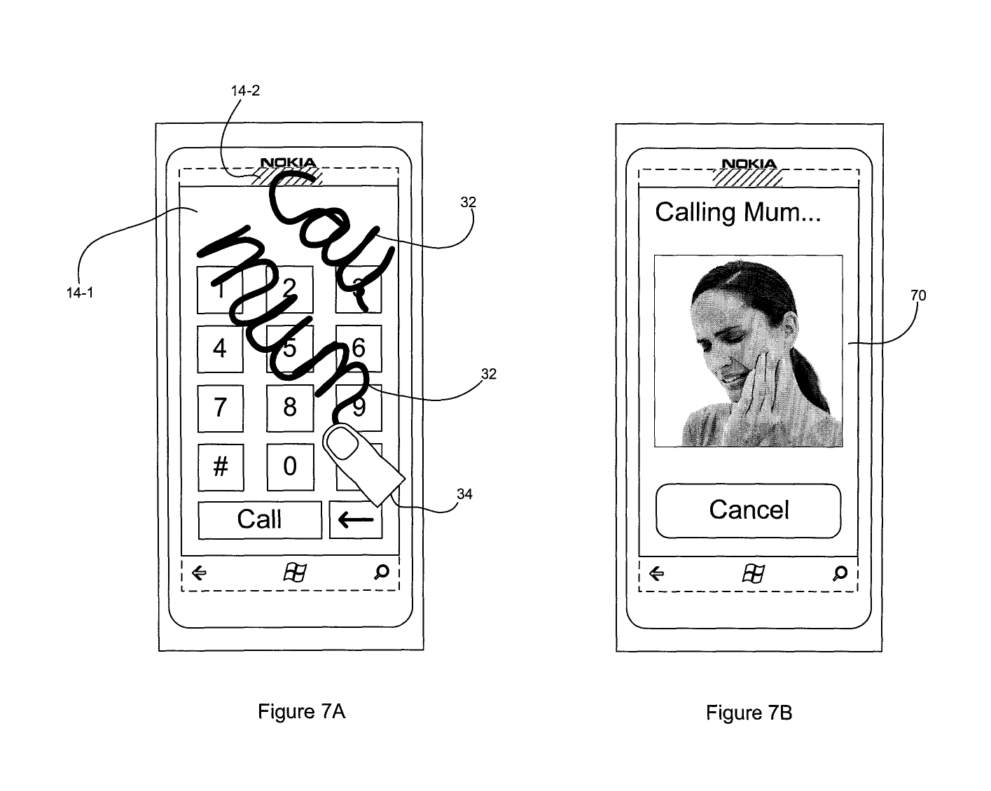

FIGS. 6A and 6B and 7A and 7B depict an electronic device performing other operations in accordance with example embodiments.

In FIG. 6A, the paths 32 of plural dynamic touch inputs spell “Find Towson”. In this example, the path of the first touch input 32-1 includes portions in the first and second regions 14-1, 14-2 of the touch-sensitive transducer 14. As such, the controller 10 passes the path data to the symbol recognition engine 16. The symbol recognition engine 16 subsequently identifies that the user has entered the text “Find Towson”. The symbol recognition engine 16 may be configured to recognise that the word “Find” is an instruction to use a mapping application to locate a place indentified by the subsequent character string. As such, this information may be returned to the controller 10 which causes a mapping application to locate a place called “Towson” and to display a map image of the place on the display. This can be seen in FIG. 6B.

In FIG. 7A, the user has handwritten the character string “Call Mum”, with the path 32-1 of the first dynamic touch input starting in the second region 14-2 and ending in the first region 14-1 of the touch-sensitive transducer 14. As such, the controller 10 passes the path data to the symbol recognition engine 16, which identifies that the user has entered the text “Call Mum”. The symbol recognition engine 16 may be configured to recognise that the word “Call” is an instruction to use a telephone application to initiate a telephone call with a contact indentified by the subsequent character string. As such, this information may be returned to the controller 10 which causes a telephone application to initiate a telephone call to the contact “Mum” and to cause and interface 70 indicative of this to be displayed. This can be seen in FIG. 7B.

It will of course be appreciated that the commands associated with the handwritten words “Call” and “Find” are examples only. The symbol recognition engine 16 may be configured to recognise many different handwritten words, which may or may not include the words “Call” and “Find”.

In some examples, the dynamic touch input starting from or finishing in the second region 14-2 of the touch-sensitive transducer 14 may be used to allow the user to change various settings on their device 2. For example, the user writing “WIFI on” may cause the controller 10 to activate the device's WIFI. Similarly, a user input spelling “BT off” may cause the controller 10 to deactivate the device's Bluetooth interface.

In other examples, the dynamic touch input may be used to write mathematical equations. For example, if the user wrote “4+4=”, the symbol recognition engine 16 may recognise one or more of the mathematical operators (i.e. the equals sign and/or the plus sign) as a command to use a calculator application to provide an answer to the hand written equation. In some examples, the controller 10 may be operable also or alternatively to work out chemical or physical equations.

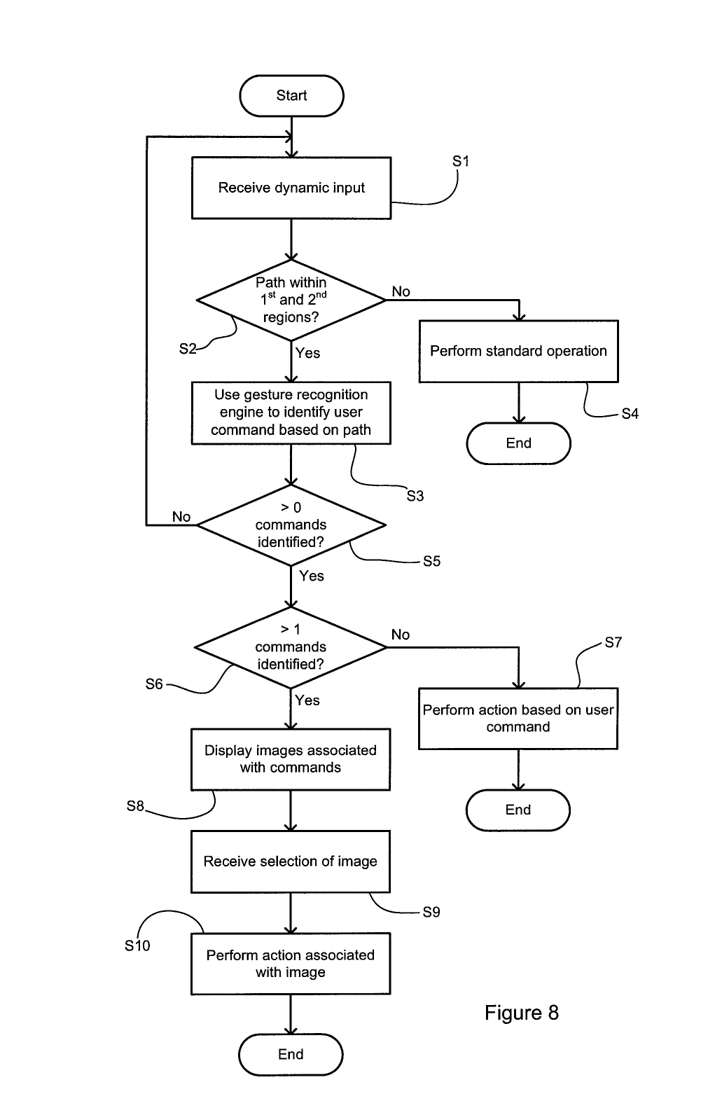

FIG. 8 is a flow chart depicting a method according to example embodiments.

In step S1, a dynamic touch input is received on the touch-sensitive transducer 14. In response to this, in step S2, the controller 10 determines if the path 32 of the dynamic touch input has portions in both the first and second regions 14-1, 14-2 of the touch-sensitive transducer 14.

In response to a negative determination in step S2, the controller to proceeds to step S4. In step S4, the controller 10 responds to the dynamic touch input in a conventional manner. This may depend on the nature of the dynamic touch input as well as the application currently displayed on the display 18.

Following a positive determination, the controller 10 proceeds to step S4. As described above, in some examples, in the order to arrive at a positive determination in step S2, the controller 10 may also require that the first and second regions 14-1, 14-2 are visited by the path in a particular order.

In some examples, prior to proceeding to step S3, the controller 10 starts a timer when an initial dynamic input (which is incident on both the first and second regions 14-1, 14-2 of the touch-sensitive transducer 14) finishes. If another dynamic touch input is received before the expiry of the timer, the controller 10 records the path data associated with this input. The timer is then restarted when the subsequent dynamic touch input is terminated. This process is repeated until the timer expires, at which point the operation proceeds to step S3.

In step S3, the controller 10 uses the symbol recognition engine 16 to identify a user command based on the shape of the path(s) 32 of the dynamic touch input(s). This may be carried out in any suitable way.

Next, in step S5, the symbol recognition engine 16 determines if any possible user commands have been identified. If no user commands have been identified on the basis of the path(s) of the dynamic touch input(s), the controller 10 is notified. The controller 10 then returns to step S1 to await another dynamic touch input. If one or more possible user commands have been identified in step S5, the operation proceeds to step S6.

In step S6, the possible user commands are provided to the controller 10 and the controller 10 determines if there is more than one possible user command. If there is only one possible user command, the controller 10 proceeds to step S7. In step S7, the controller 10 causes an action to be performed based on the identified user command. Such actions may include switching to a different application to that currently being used. Depending on the identified user command, the controller 10 may also cause an action to be performed by the new application. Subsequent to step S7, the method ends.

If, in step S6, it is determined that there are plural possible user commands, the method proceeds to step S8. In step S8, the controller 10 causes a plurality of selectable images to be displayed, each image being associated with a different one of the plural possible user commands.

Next, in step S9, the controller 10 receives a selection of one of the images. In response to this, in step S10, the controller 10 causes an action associated with the selected image to be performed. Similarly to step S7, this may, for example, comprise switching to an application that is different to that currently being displayed. The action caused by the controller 10 may optionally also include the new application also performing an action, such as a search. Subsequent to step S10, the method ends.

In some examples, in addition to the first and second regions 14-1, 14-2, one or more other regions (not shown in the figures) of the touch-sensitive transducer 14 may be recognised by the controller 10. For example, a dynamic touch input may start in the second region, may pass through the first region 14-3 and may finish in a third region. The controller 10 may be responsive to detection of this to perform an action, the action being identified based on the symbol(s) defined by the path of the dynamic touch input and based on the fact that the path terminated in the third region. For example, if the user writes a command for causing an email application to be opened, ending the path in the third region may cause the email application to open a new message. In this way, the user is able to use a single input to open the email application and also to cause a new message to be opened. In some examples, more than one other region may be defined, with the action depending on which of the other regions is entered by the path of the dynamic touch input. For example, the handwritten symbol may indicate that the user wishes to write a new email and the choice of other region may indicate from which email account they may wish to send the email or to whom they wish to send the email. It will of course be appreciated that in some examples the dynamic touch input may instead start in the other region, may pass through the first region 14-1 and may finish in the second region 14-2. In other examples, the third region may be associated with a delete function. As such, if a dynamic user input ends or starts in the third region, the controller 10 may cause a file from an application identified based on the path of the dynamic input to be deleted from the memory 12.

In some examples, ending the dynamic touch input in a third region may cause the controller 10 to disregard the whole input. In this way, if the user changes their mind while providing an input, they can simply drag their finger to a third region of the transducer to cancel the operation.

In some examples, the controller 10 may be operable to cause the handwritten symbols (i.e. the path of a dynamic touch input or series of inputs) to be displayed as a note on, for example, a lock screen of the device 2. This may be caused by, for example, the path of the touch input or series of touch inputs terminating in a third region of the transducer. Alternatively, there may be an associated symbol, the entry of which results in the path of the inputs being displayed on the display until the user chooses to remove it. For example, the user may handwrite “memo” or “note” and the controller 10 may interpret this as a command to display the path of the dynamic input.

Although the above example embodiments have been described with reference to touch inputs, many touch-sensitive transducers are operable also to detect hover inputs. A hover input is when a user does not actually touch the transducer, but instead positions their finger slightly above the surface of the transducer 14. A dynamic hover input can therefore be provided by the user moving their finger in a direction substantially parallel to the plane of the touch-sensitive transducer 14 but a short distance above the surface of the touch-sensitive transducer 14. The path of a dynamic hover input is defined by the locations on the touch-sensitive transducer at which the hover input is detected as the user moves their finger parallel to the surface.

In view of the above, the term “dynamic input” used herein should be understood to include both dynamic touch inputs and dynamic hover inputs.

As described above, the symbol recognition engine 16 is operable to recognise alphabetic characters based on the path of a dynamic input. The characters are not limited to those of the Roman alphabet, but may be characters from any writing system. In addition, the symbol recognition engine 16 may be configured to recognise user defined symbols. These may have been pre-provided by the user and may have been pre-assigned to a particular user command. Similarly, the apparatus may be configurable such that a user can define the user commands that are associated with a particular custom or standard symbol.

In the above examples, the symbol recognition engine 16 is responsible for identifying the user commands. However, in some examples, symbol recognition engine 16 may simply be configured to decipher the handwritten symbols. The symbol recognition engine 16 may then return information identifying the symbols to the controller 10. The controller 10 subsequently performs the operation of identifying the user commands based on the information returned by the symbol recognition engine 16.

In the above-described examples, touch and hover inputs have been provided by a user's finger. It will, however be appreciated that any suitable member, such as the user's thumb or a stylus, may be used.

In the above examples, the path data is transferred to the symbol recognition engine 16 after the dynamic input (or series of dynamic inputs) has finished being provided. In other examples, however, this transfer may occur as the input is being provided. As such, the symbol recognition engine may be analysing the path of the dynamic touch input as it is provided.

The example embodiments described herein provide a fast, accurate and efficient method for navigating around a device. In order for user to access a particular application, the user may provide a single dynamic user input, which can be provided regardless of the application currently being displayed on the display. As such, the user is not required to return to a central menu in order to locate and then access the desired application.

Current symbol recognition is more accurate than voice recognition and so the example embodiments provide a more efficient method of providing user commands, than is currently available on voice-controlled user interfaces. In addition, the operations according to example embodiments can be utilised in situations when silence or minimal noise is required, such as meetings.

In addition, example embodiments do not require the user to provide an initial input to set the device into “symbol recognition mode”. This is performed automatically when the user moves the dynamic input from the second region 14-2 to the first 14-1. As such, the fewer inputs are required than in current voice-controlled user interfaces in which an initial input, such as a long key press, is required in order to initiate the voice recognition application.

In examples in which the second region 14-2 is located in a rarely used part of the touch-sensitive transducer 14, such as outside the perimeter of the display, the chances of accidental commands being provided when the user was simply attempting to perform an operation with the currently displayed interface are minimal.

It should be realized that the foregoing embodiments should not be construed as limiting. Other variations and modifications will be apparent to persons skilled in the art upon reading the present application. Moreover, the disclosure of the present application should be understood to include any novel features or any novel combination of features either explicitly or implicitly disclosed herein or any generalization thereof and during the prosecution of the present application or of any application derived therefrom, new claims may be formulated to cover any such features and/or combination of such features.

1. A method comprising:
receiving signals indicative of receipt of a dynamic input by a touch-sensitive transducer, the dynamic input defining a path on the touch-sensitive transducer, at least a first portion of the path being within a first region of the touch-sensitive transducer;
determining if a second portion of the path of the dynamic input is within a second region of the touch-sensitive transducer;
in response to determining that the second portion of the path of the dynamic input is within the second region of the display, using a symbol recognition engine to identify a command based on the path of the dynamic input; and
causing an action to be performed based on the identified command.

2. The method of claim 1, wherein the touch-sensitive transducer is part of a touchscreen device and wherein the first region of the touch-sensitive transducer overlies a display panel to form the touchscreen of the touchscreen device, and wherein the second region of the touch-sensitive transducer is located outside the perimeter of the display panel.

3. The method of claim 1, wherein the path originates in the second region and terminates in the first region or the path originates in the first region and terminates in the second region.

4. The method of claim 1, wherein the action comprises switching from displaying an interface of a first application to displaying an interface of a second application.

5. The method of claim 4, wherein the action comprises identifying at least one application based on the command and, for each of the at least one application, displaying a selectable image associated with the application.

6. The method of claim 5, further comprising responding to receipt of signals indicative of a user selection of one of the at least one selectable image by causing display of an interface of the application associated with the selected image.

7. Apparatus comprising at least one processor and at least one memory including computer program code, the at least one memory and the computer program code configured, with the at least one processor, to cause the apparatus:
to receive signals indicative of receipt of a dynamic input by a touch-sensitive transducer, the dynamic input defining a path on the touch-sensitive transducer, at least a first portion of the path being within a first region of the touch-sensitive transducer;
to determine if a second portion of the path of the dynamic input is within a second region of the touch-sensitive transducer;
in response to determining that the second portion of the path of the dynamic input is within the second region of the display, to use a symbol recognition engine to identify a command based on the path of the dynamic input; and
to cause an action to be performed based on the identified command.

8. The apparatus of claim 7, wherein the touch-sensitive transducer is part of a touchscreen device and wherein the first region of the touch-sensitive transducer overlies a display panel to form the touchscreen of the touchscreen device, and wherein the second region of the touch-sensitive transducer is located outside the perimeter of the display panel.

9. The apparatus of claim 7, wherein the path originates in the second region and terminates in the first region or the path originates in the first region and terminates in the second region.

10. The apparatus of claim 7, wherein the action comprises switching from displaying an interface of a first application to displaying an interface of a second application.

11. The apparatus of claim 10, wherein the action comprises identifying at least one application based on the command and, for each of the at least one application, displaying a selectable image associated with the application.

12. The apparatus of claim 11, the at least one memory and the computer program code being configured, with the at least one processor, to cause the apparatus to respond to receipt of signals indicative of a user selection of one of the at least one selectable image by causing display of an interface of the application associated with the selected image.

13. (canceled)

14. A non-transitory computer-readable storage medium having stored thereon computer-readable code, which, when executed by computing apparatus, causes the computer apparatus:
to receive signals indicative of receipt of a dynamic input by a touch-sensitive transducer, the dynamic input defining a path on the touch-sensitive transducer, at least a first portion of the path being within a first region of the touch-sensitive transducer;
to determine if a second portion of the path of the dynamic input is within a second region of the touch-sensitive transducer;
in response to determining that the second portion of the path of the dynamic input is within the second region of the display, to use a symbol recognition engine to identify a command based on the path of the dynamic input; and
to cause an action to be performed based on the identified command.

15. (canceled)

16. The storage medium of claim 14, wherein the touch sensitive transducer is part of a touchscreen device and wherein the first region of the touch-sensitive transducer overlies a display panel to form the touchscreen of the touchscreen device, and wherein the second region of the touch-sensitive transducer is located outside a perimeter of the display panel.

17. The storage medium of claim 14, wherein the path originates in the second region and terminates in the first region or the path originates in the first region and terminates in the second region.

18. The storage medium of claim 14, wherein the action comprises switching from displaying an interface of a first application to displaying an interface of a second application.

19. The storage medium of claim 18, wherein the action comprises identifying at least one application based on the command and, for each of the at least one application, displaying a selectable image associated with the application.

20. The storage medium of claim 19, wherein the computer-readable code, when executed by the computing apparatus, causes the computer apparatus to respond to receipt of signals indicative of a user selection of one of the at least one selectable image by causing display of an interface of the application associated with the selected image.

21. The apparatus of claim 8, wherein the path originates in the second region and terminates in the first region or the path originates in the first region and terminates in the second region.

22. The apparatus of claim 22, wherein the action comprises switching from displaying an interface of a first application to displaying an interface of a second application.
